(19) United States
(12) Patent Application Publication
(10) Pub. No.: US 2017/0271079 A1
(43) Pub. Date: Sep. 21, 2017

(54) CAPACITOR CONNECTION STRUCTURE OF POWER CONVERSION DEVICE AND METHOD FOR CONNECTING CAPACITOR GROUP

(71) Applicant: FUJI ELECTRIC CO., LTD., Kawasaki (JP)

(72) Inventor: Kiyoshi TAKAHASHI, Sagamahara (JP)

(73) Assignee: FUJI ELECTRIC CO., LTD., Kawasaki (JP)

(21) Appl. No.: 15/412,956

(22) Filed: Jan. 23, 2017

(30) Foreign Application Priority Data
Mar. 16, 2016 (JP) 2016-052533

(51) Int. Cl. H01G 2/16; H01G 2/10; H01G 2/04

(52) U.S. Cl. CPC H01G 2/16; H01G 2/04; H01G 2/10

(57) ABSTRACT

A capacitor connection structure of a power conversion device, includes a capacitor having a capacitor end face from which a positive electrode terminal and a negative electrode terminal protrudes that is deformed outward into a convex shape when the fuse is blown, a positive electrode-side main conductor and a negative electrode-side main conductor that are formed by a thick plate and that are connected to another electronic component at positions facing the capacitor end face; a positive electrode-side intermediate conductor that connects the positive electrode terminal to the positive electrode-side main conductor; and a negative electrode-side intermediate conductor that connects the negative electrode terminal to the negative electrode-side main conductor. When the capacitor end face is deformed into the convex shape, the positive electrode-side intermediate conductor and the negative electrode-side intermediate conductor are deformed along with inclination of the positive electrode terminal and the negative electrode terminal.

### CROSS REFERENCE TO RELATED APPLICATIONS AND INCORPORATION BY REFERENCE

This application claims benefit of priority under 35 USC 119 based on Japanese Patent Application No. 2016-052533 filed on Mar. 16, 2016, the entire contents of which are incorporated by reference herein.

### TECHNICAL FIELD

The present invention relates to a structure for connecting one or more of capacitors mounted in a power conversion device to another electronic component via a conductor and a method for connecting a capacitor group.

### BACKGROUND ART

For example, the structure described in JP 2002-44964 A (see FIG. 1) is known as the structure for connecting one or more of capacitors mounted in a power conversion device to another electronic component via a conductor.

In the structure described in JP 2002-44964 A, a plurality of cylindrical capacitors are arranged in line in a state where one end face of each capacitor having a positive electrode-side terminal and a negative electrode-side terminal protruding therefrom is oriented in the same direction.

The conductor that connects the plurality of capacitors to another electronic component is a plate-shaped conductor having high bending rigidity formed by layering a positive electrode-side conductive plate, a negative electrode-side conductive plate, and an insulator interposed therebetween. The positive electrode-side terminal of each capacitor is connected to the positive electrode-side conductive plate of the plate-shaped conductor by being screwed to fixing screws, the negative electrode-side terminal of each capacitor is connected to the negative electrode-side conductive plate of the conductor by being screwed to fixing screws, and the positive electrode-side conductive plate and the negative electrode-side conductive plate of the conductor are connected to a positive electrode-side terminal and a negative electrode-side terminal of the other electronic component.

Meanwhile, use of a capacitor in an overload state or an overvoltage state can cause bursting of the capacitor or scattering of liquid sealed in the capacitor out of an anti-burst valve, as a result of which the scattered liquid can adhere to an electronic component mounted in a power conversion device.

In order to prevent such a problem, it is known to mount capacitors with a built-in fuse in a power conversion device. When a capacitor with a built-in fuse goes into an overload state or an overvoltage state, the fuse is blown due to an increase in internal temperature. Then, when internal pressure is increased, an end face of the capacitor having a positive electrode-side terminal and a negative electrode-side terminal protruding therefrom is deformed outward into a convex shape to reduce the internal pressure, thereby preventing the bursting of the capacitor and scattering of the liquid.

SUMMARY OF INVENTION

Meanwhile, in the case of employing capacitors with a built-in fuse as the capacitors described in JP 2002-44964 A, even when any of the capacitors goes into an overload state or an overvoltage state and the end face of the capacitor with a built-in fuse tries to deform into a convex shape, the plate-shaped conductor to which the positive electrode-side terminal and the negative electrode-side terminal are connected can obstruct the deformation of the end face of the capacitor with a built-in fuse.

Thus, it is an object of the present invention to provide a capacitor connection structure of a power conversion device and a method for connecting a capacitor group, which do not obstruct deformation of a capacitor end face of a capacitor with a built-in fuse in an overload state or an overvoltage state even when the capacitor end face having a positive electrode terminal and a negative electrode terminal protruding therefrom tries to deform into a convex shape.

In order to achieve the object mentioned above, according to an aspect of the present invention, there is provided a capacitor connection structure of a power conversion device, including: a capacitor with a built-in fuse, in which when the fuse is blown, a capacitor end face having a positive electrode terminal and a negative electrode terminal protruding from the capacitor end face is deformed outward into a convex shape; a positive electrode-side main conductor and a negative electrode-side main conductor that are formed by a thick plate and that are connected to another electronic component at positions facing the capacitor end face; a positive electrode-side intermediate conductor that connects the positive electrode terminal to the positive electrode-side main conductor; and a negative electrode-side intermediate conductor that connects the negative electrode terminal to the negative electrode-side main conductor, wherein when the capacitor end face is deformed into the convex shape, the positive electrode-side intermediate conductor and the negative electrode-side intermediate conductor are deformed along with inclination of the positive electrode terminal and the negative electrode terminal.

Furthermore, according to another aspect of the present invention, there is provided a method for connecting a capacitor group of a power conversion device, which is a method for connecting a plurality of capacitors arranged in line to the another electronic component by using the capacitor connection structure of the power conversion device described above, the method including: arranging a plurality of capacitors in line so that the positive electrode terminal and the negative electrode terminal protruding from the capacitor end face are oriented in the same direction; arranging the positive electrode-side main conductor having a long length along a direction in which the positive electrode terminals of the plurality of capacitors are arrayed; arranging the negative electrode-side main conductor having a long length along a direction in which the negative electrode terminals of the plurality of capacitors are arrayed; connecting the positive electrode terminal of each of the plurality capacitors to the positive electrode-side main conductor by the positive electrode-side intermediate conductor; and connecting the negative electrode terminal of each of the plurality capacitors to the negative electrode-side main conductor by the negative electrode-side intermediate conductor.

According to the capacitor connection structure of a power conversion device and the method for connecting a capacitor group according to the aspects of the present invention, when a capacitor with a built-in fuse is in an overload state or an overvoltage state, a capacitor end face of the capacitor whose shape will be deformed due to an increase in internal pressure can be deformed into a convex shape without being obstructed so that the fuse is normally blown.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a diagram depicting a planar view of a capacitor group mounted in a power conversion device of a first embodiment according to the present invention;

FIG. 2 is a diagram depicting the arrangement of a plurality of capacitors from a direction indicated by arrow II of FIG. 1;

FIG. 3 is a diagram depicting the arrangement of a plurality of capacitors from a direction indicated by arrow III of FIG. 1;

FIG. 4 is a perspective view depicting a positive electrode-side intermediate conductor and a negative electrode-side intermediate conductor used in a capacitor connection structure of the first embodiment according to the present invention;

FIG. 5 is a diagram depicting a state where the positive electrode-side intermediate conductor is connected between a positive electrode-side main conductor and a positive electrode terminal of a capacitor and the negative electrode-side intermediate conductor is connected between a negative electrode-side main conductor and a negative electrode terminal of the capacitor in the first embodiment according to the present invention;

FIG. 6 is a diagram depicting the state of deformation of the positive electrode-side intermediate conductor and the negative electrode-side intermediate conductor when an end face of a capacitor with a built-in fuse having a positive electrode terminal and a negative electrode terminal protruding therefrom is deformed into a convex shape in the first embodiment according to the present invention; and

FIG. 7 is a diagram depicting a state where a negative electrode-side intermediate conductor is connected between the negative electrode-side main conductor and the negative electrode terminals of two adjacent capacitors in a second embodiment according to the present invention.

### DETAILED DESCRIPTION

Next, first and second embodiments of the present invention will be described with reference to the drawings. In the descriptions of the drawings below, the same or similar parts are denoted by the same or similar reference signs. However, it is to be noted that the drawings are schematic, and relationships between thickness and planar size, ratios between the thicknesses of respective layers, and the like may be different from actual ones. Accordingly, specific thicknesses and sizes should be determined in consideration of the following descriptions. Additionally, it is obvious that the drawings each may include parts mutually different in dimensional relationship and ratio.

In addition, the first and second embodiments given below exemplify devices and methods for embodying the technical ideas of the present invention, and therefore the technical ideas thereof are not limited to the following materials, shapes, structures, arrangements, and the like of constituent components. Various changes can be added to the technical ideas of the present invention within the technical ranges as defined by the appended claims.

### [Capacitor Connection Structure According to First Embodiment]

Hereinafter, an embodiment for implementing the present invention (hereinafter referred to as embodiment) will be described in detail with reference to the drawings.

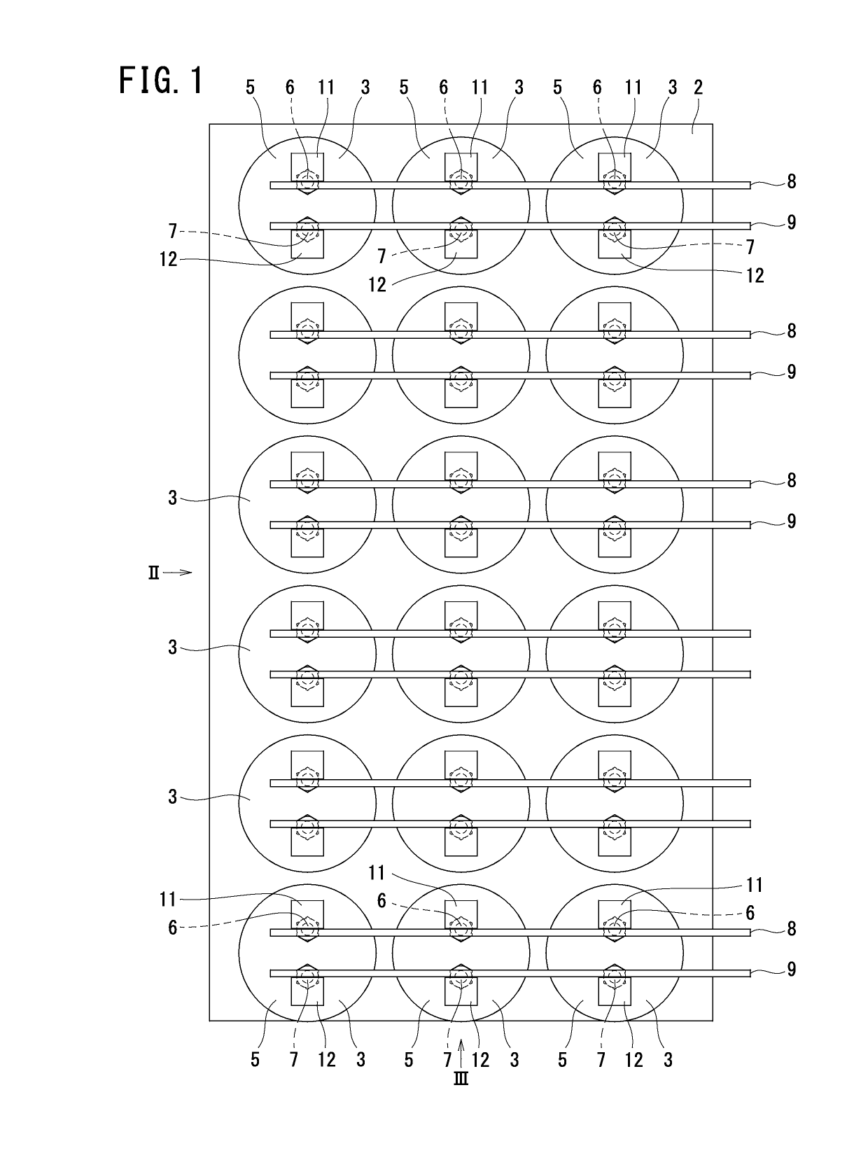

FIG. 1 depicts a capacitor group 1 mounted in a power conversion device.

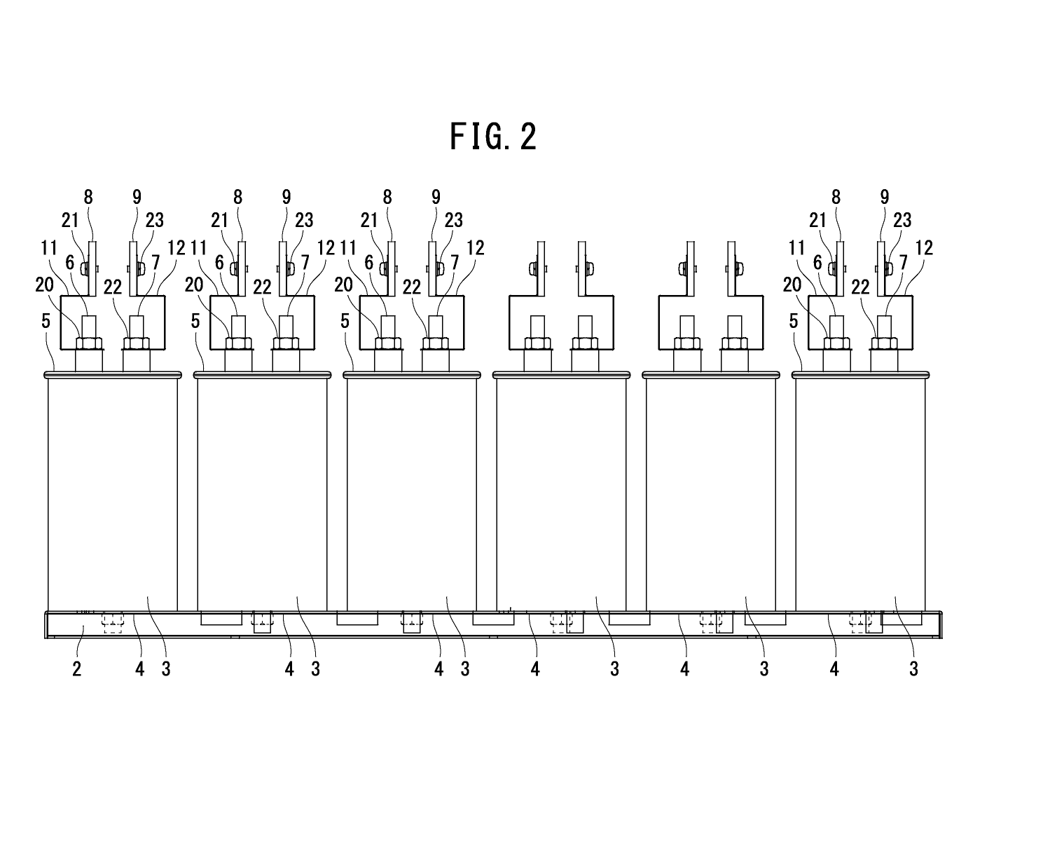

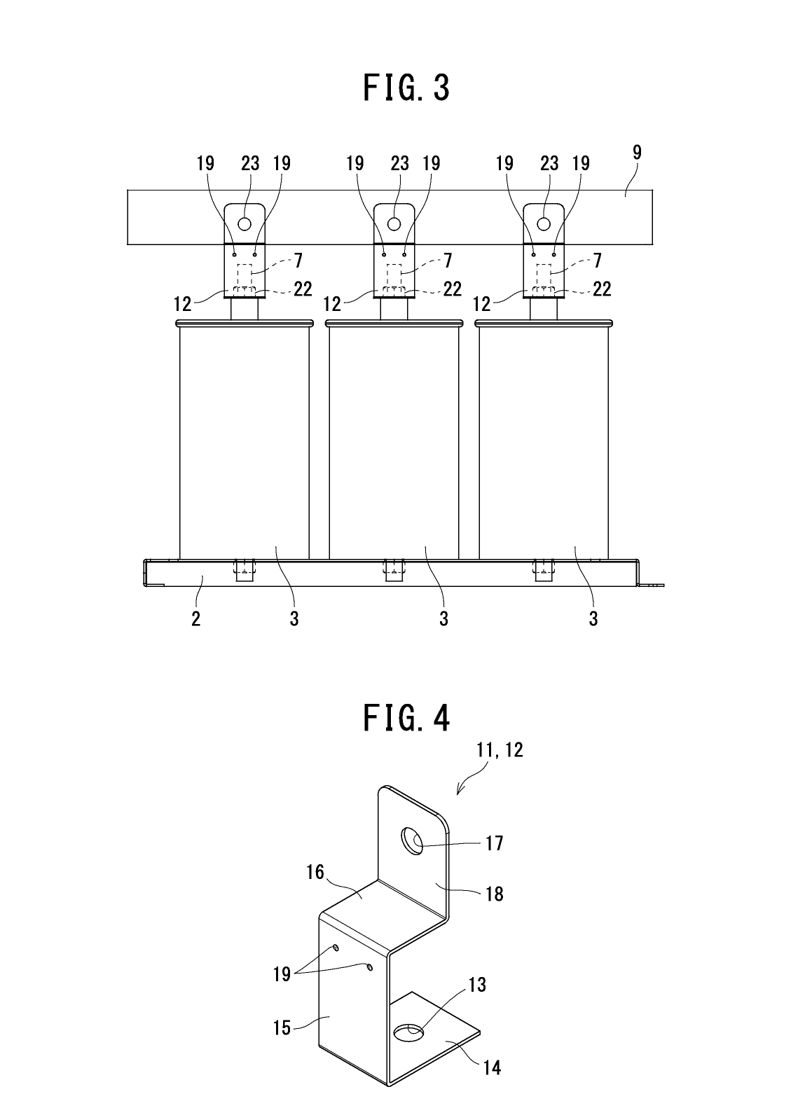

The capacitor group 1 includes six lines (see also FIG. 2) of three capacitors 3 per line arranged in an up-and-down direction of FIG. 1 on a mounting base 2 (see also FIG. 3).

As depicted in FIG. 2, each capacitor 3 is an externally cylindrical capacitor with a built-in fuse. One end face of the capacitor 3 is mounted and fixed onto the mounting base 2 and the other end face thereof is positioned at an upper side. Here, the one end face thereof is referred to as bottom surface 4, and the other end face thereof is referred to as top surface 5.

On the top surface 5 of each capacitor 3, a positive electrode terminal 6 and a negative electrode terminal 7 are provided protruding upward therefrom. Each capacitor 3 is arranged on the mounting base 2 so that the positive electrode terminal 6 and the negative electrode terminal 7 are spaced apart from each other in a line direction (the up-and-down direction of FIG. 1, and a right-and-left direction of FIG. 2). Additionally, on outer peripheries of the positive electrode terminal 6 and the negative electrode terminal 7 is formed a male thread (unillustrated).

Then, as depicted in FIGS. 1 and 2, a positive electrode-side main conductor 8 and a negative electrode-side main conductor 9 extend above the plurality of capacitors 3 of each line of the capacitor group 1.

The positive electrode-side main conductor 8 and the negative electrode-side main conductor 9 are formed by a hardly deformable, long and thick plate. The main conductors 8 and 9 are supported by an unillustrated conductor support unit in a state where short-length directions of the main conductors 8 and 9 are oriented in the up-and-down direction, and extend above the plurality of capacitors 3 of each line in such a manner that mutual long-length directions thereof are parallel to each other and are located at the same height.

Then, a positive electrode-side intermediate conductor 11 is connected between the positive electrode-side main conductor 8 and the positive electrode terminal 6 of the capacitor 3, and a negative electrode-side intermediate conductor 12 is connected between the negative electrode-side main conductor 9 and the negative electrode terminal 7 of the capacitor 3.

The positive electrode-side intermediate conductor 11 and the negative electrode-side intermediate conductor 12 are members having the same shape formed by bending an easily deformable thin plate.

As depicted in FIG. 4, the positive electrode-side intermediate conductor 11 and the negative electrode-side intermediate conductor 12 include a terminal connection portion 14 having a terminal passing hole 13 formed therein, a first non-contact portion 15 formed by bending the intermediate conductor at a right angle from an end of the terminal connection portion 14, a second non-contact portion 16 that is formed by bending the intermediate conductor at a right angle from an end of the first non-contact portion 15 and that extends in parallel to the terminal connection portion 14, and a main conductor connection portion 18 that is formed by bending the intermediate conductor at a right angle from an end of the second non-contact portion 16 in a direction in which the portion 18 is spaced apart from the terminal connection portion 14 and that has a screw passing hole 17 formed therein.

Additionally, on aside of the first non-contact portion 15 closer to the second non-contact portion 16, two deformation promoting holes 19 are formed away from each other at positions along a bent line between the first non-contact portion 15 and the second non-contact portion 16 by piercing through the first non-contact portion 15 from front to back.

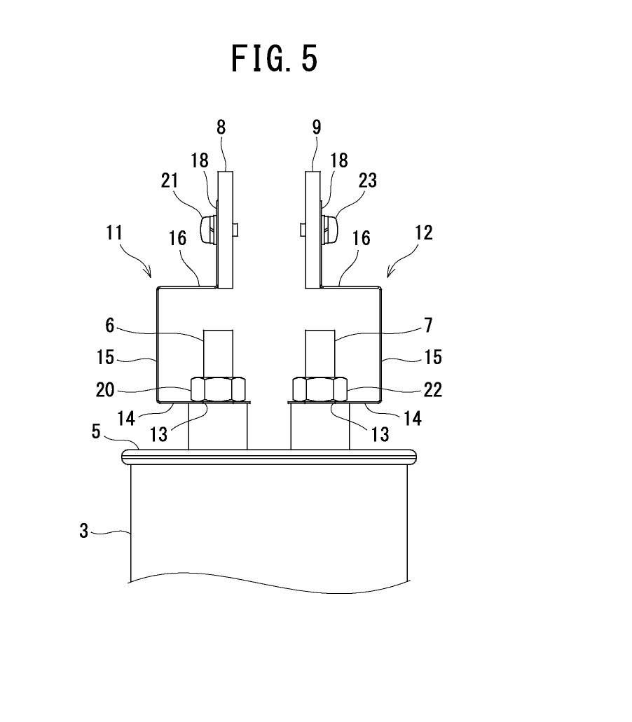

Then, as depicted in FIG. 5, in the positive electrode-side intermediate conductor 11, the positive electrode terminal 6 is inserted through the terminal passing hole 13, and, in a state where the first non-contact portion 15 and the second non-contact portion 16 are arranged at positions spaced apart from the negative electrode terminal 7, the main conductor connection portion 18 is abutted against a side surface of the positive electrode-side main conductor 8. Then, a nut 20 screwed to the male thread of the positive electrode terminal 6 is tightened to thereby fix the terminal connection portion 14 to the positive electrode terminal 6, and a fixing screw 21 inserted through the screw passing hole 17 of the main conductor connection portion 18 is screwed to a female thread (unillustrated) of the positive electrode-side main conductor 8 to thereby fix the main conductor connection portion 18 to the positive electrode-side main conductor 8.

In addition, in the negative electrode-side intermediate conductor 12, the negative electrode terminal 7 is inserted through the terminal passing hole 13, and in a state where the first non-contact portion 15 and the second non-contact portion 16 are arranged at positions spaced apart from the positive electrode terminal 6, the main conductor connection portion 18 is abutted against a side surface of the negative electrode-side main conductor 9. Then, a nut 22 screwed to the male thread of the negative electrode terminal 7 is tightened to thereby fix the terminal connection portion 14 to the negative electrode terminal 7, and a fixing screw 23 inserted through the screw passing hole 17 of the main conductor connection portion 18 is screwed to a female thread (unillustrated) of the negative electrode-side main conductor 9 to thereby fix the main conductor connection portion 18 to the negative electrode-side main conductor 9.

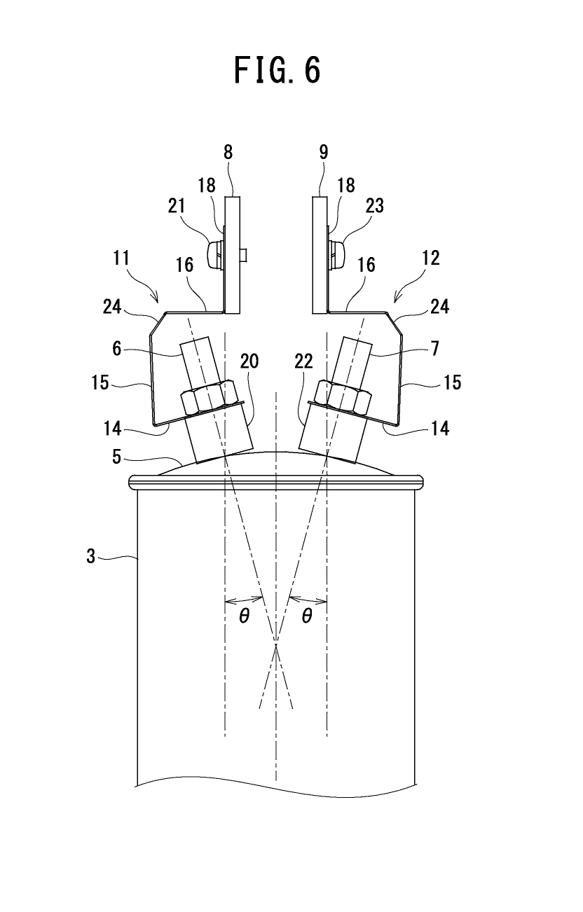

Meanwhile, the capacitors 3 of the first embodiment are capacitors with a built-in fuse, in which when any of the capacitors 3 goes into an overload state or an overvoltage state, the fuse is blown due to an increase in internal temperature and the internal pressure is increased, whereby the top surface 5 is deformed upward into a convex shape (see FIG. 6). Then, as depicted in FIG. 6, when the top surface 5 is deformed into the convex shape, the positive electrode terminal 6 and the negative electrode terminal 7 also incline in a range of θ=10 to 30° with respect to reference lines in the up-and-down direction.

Thus, the first non-contact portions 15 and the second non-contact portions 16 of the positive electrode-side intermediate conductor 11 and the negative electrode-side intermediate conductor 12 are formed at positions sufficiently spaced apart from top ends of the positive electrode terminal 6 and the negative electrode terminal 7 so that the top ends of the positive electrode terminal 6 and the negative electrode terminal 7 do not come in contact therewith even when the positive electrode terminal 6 and the negative electrode terminal 7 are inclined to a maximum angle (for example, θ=30°) due to a convex deformation of the top surface 5.

In addition, the positive electrode-side intermediate conductor 11 connected between the positive electrode-side main conductor 8 and the positive electrode terminal 6 of the capacitor 3 and the negative electrode-side intermediate conductor 12 connected between the negative electrode-side main conductor 9 and the negative electrode terminal 7 of the capacitor 3 are arranged within a circular range formed by the top surface 5 of the capacitor 3, as depicted in FIG. 1.

A positive electrode terminal connection portion according to the present invention corresponds to the terminal connection portion 14 of the positive electrode-side intermediate conductor 11, a positive electrode non-contact portion according to the present invention corresponds to the first non-contact portion 15 and the second non-contact portion 16 of the positive electrode-side intermediate conductor 11, and a positive electrode main conductor connection portion according to the present invention corresponds to the main conductor connection portion 18 of the positive electrode-side intermediate conductor 11.

In addition, a negative electrode terminal connection portion according to the present invention corresponds to the terminal connection portion 14 of the negative electrode-side intermediate conductor 12, a negative electrode non-contact portion according to the present invention corresponds to the first non-contact portion 15 and the second non-contact portion 16 of the negative electrode-side intermediate conductor 12, and a negative electrode main conductor connection portion according to the present invention corresponds to the main conductor connection portion 18 of the negative electrode-side intermediate conductor 12.

Furthermore, a capacitor end face according to the present invention corresponds to the top surface 5.

### [Method for Connecting Capacitor Group of First Embodiment]

Next, a description will be given of a method for mounting the capacitor group 1 in a power conversion device and connecting the capacitor group 1 to another electronic component via the positive electrode-side main conductor 8 and the negative electrode-side main conductor 9.

First, six lines of three capacitors 3 per line are arranged on the mounting base 2 of the power conversion device. Each capacitor 3 is arranged so that the positive electrode terminal 6 and the negative electrode terminal 7 are aligned in the line direction (in each line of FIG. 1, the positive electrode terminals 6 are on an upper side, and the negative electrode terminals 7 are on a lower side).

Next, the positive electrode-side main conductor 8 and the negative electrode-side main conductor 9 connected to the other electronic component are arranged above the top surface 5 of each capacitor 3.

Then, the positive electrode-side intermediate conductor 11 is connected between the positive electrode-side main conductor 8 and the positive electrode terminal 6 of the capacitor 3, and the negative electrode-side intermediate conductor 12 is connected between the negative electrode-side main conductor 9 and the negative electrode terminal 7 of the capacitor 3.

In this case, the positive electrode-side intermediate conductor 11 allows the positive electrode terminal 6 to be inserted through the terminal passing hole 13, and allows the main conductor connection portion 18 to abut against the side surface of the positive electrode-side main conductor 8 in the state where the first non-contact portion 15 and the second non-contact portion 16 are arranged at the positions spaced apart from the negative electrode terminal 7. Then, the nut 20 screwed to the male thread of the positive electrode terminal 6 is tightened to thereby fix the terminal connection portion 14 to the positive electrode terminal 6, and the fixing screw 21 inserted through the screw passing hole 17 of the main conductor connection portion 18 is screwed to the female thread of the positive electrode-side main conductor 8 to thereby fix the main conductor connection portion 18 to the positive electrode-side main conductor 8.

Additionally, the negative electrode-side intermediate conductor 12 allows the negative electrode terminal 7 to be inserted through the terminal passing hole 13, and allows the main conductor connection portion 18 to abut against the side surface of the negative electrode-side main conductor 9 in the state where the first non-contact portion 15 and the second non-contact portion 16 are arranged at the positions spaced apart from the positive electrode terminal 6. Then, the nut 22 screwed to the male thread of the negative electrode terminal 7 is tightened to thereby fix the terminal connection portion 14 to the negative electrode terminal 7, and the fixing screw 23 inserted through the screw passing hole 17 of the main conductor connection portion 18 is screwed to the female thread of the negative electrode-side main conductor 9 to thereby fix the main conductor connection portion 18 to the negative electrode-side main conductor 9.

This completes the mounting of the capacitor group 1 in the power conversion device and connection of the capacitor group 1 to the other electronic component via the positive electrode-side main conductor 8 and the negative electrode-side main conductor 9.

### [Advantageous Effects of First Embodiment]

Next, a description will be given of functions and effects of the capacitor connection structure and the method for connecting a capacitor group of the first embodiment. When the each capacitor 3 that is a capacitor with a built-in fuse goes into an overload state or an overvoltage state, the fuse is blown due to an increase in internal temperature, and the internal pressure is increased, thereby causing the top surface 5 to be deformed upward into a convex shape, as depicted in FIG. 6. Then, when the top surface 5 is deformed into the convex shape, the positive electrode terminal 6 and the negative electrode terminal 7 of the capacitor 3 also incline in the range of θ=10 to 30° with respect to reference lines in the up-and-down direction.

Along with the inclination of the positive electrode terminal 6 and the negative electrode terminal 7, an interfacial portion between the terminal connection portion 14 and the first non-contact portion 15 of the positive electrode-side intermediate conductor 11 and an interfacial portion between the terminal connection portion 14 and the first non-contact portion 15 of the negative electrode-side intermediate conductor 12 fixed to the positive electrode terminal 6 and the negative electrode terminal 7 become deformed.

In addition, a deformation force transmitted to the first non-contact portions 15 of the positive electrode-side intermediate conductor 11 and the negative electrode-side intermediate conductor 12 is transmitted to the surroundings of the deformation promoting holes 19 formed in the first non-contact portions 15, whereby the surroundings of the deformation promoting holes 19 are deformed, resulting in formation of bent portions 24.

In this way, when the positive electrode terminal 6 and the negative electrode terminal 7 are inclined due to the convex deformation of the top surface 5, the positive electrode-side intermediate conductor 11 and the negative electrode-side intermediate conductor 12 are deformed while being sufficiently spaced apart from the top ends of the positive electrode terminal 6 and the negative electrode terminal 7.

Accordingly, in the capacitor connection structure of the first embodiment, even when the top surface 5 of the capacitor 3 in an overload state or an overvoltage state is deformed into the convex shape and thereby the positive electrode terminal 6 and the negative electrode terminal 7 become inclined, the positive electrode-side intermediate conductor 11 connecting the positive electrode terminal 6 of the capacitor 3 to the positive electrode-side main conductor 8 and the negative electrode-side intermediate conductor 12 connecting the negative electrode terminal 7 of the capacitor 3 to the negative electrode-side main conductor 9 are deformed in directions in which the intermediate conductors 11 and 12 do not come in contact with the positive electrode terminal 6 and the negative electrode terminal 7. Thus, the capacitor connection structure does not obstruct the deformation of the top surface 5 of the capacitor 3.

Additionally, since the positive electrode-side intermediate conductor 11 connected between the positive electrode-side main conductor 8 and the positive electrode terminal 6 of the capacitor 3 and the negative electrode-side intermediate conductor 12 connected between the negative electrode-side main conductor 9 and the negative electrode terminal 7 of the capacitor 3 are the members having the same shape formed by bending an easily deformable thin plate, maintenance and replacement cost for the power conversion device can be significantly reduced.

In addition, the six lines of the three capacitors 3 per line are arranged on the mounting base 2, the positive electrode-side main conductor 8 and the negative electrode-side main conductor 9 are arranged above the top surface 5 of each capacitor 3, the positive electrode-side intermediate conductor 11 is connected between the positive electrode terminal 6 of each capacitor 3 and the positive electrode-side main conductor 8, and the negative electrode-side intermediate conductor 12 is connected between the negative electrode terminal 7 of each capacitor 3 and the negative electrode-side main conductor 9 of each capacitor 3. With only the above arrangement, the connection of the capacitor group 1 is completed, so that assembly cost reduction can be also achieved.

Furthermore, as depicted in FIG. 1, the positive electrode-side intermediate conductor 11 and the negative electrode-side intermediate conductor 12 are arranged within the circular range formed by the top surface 5 of each capacitor 3, and the capacitor group 1 can be mounted on the mounting base 2 having a small area by narrowing the distance between the adjacent capacitors 3, so that a compact power conversion device can be provided.

### [Capacitor Connection Structure of Second Embodiment]

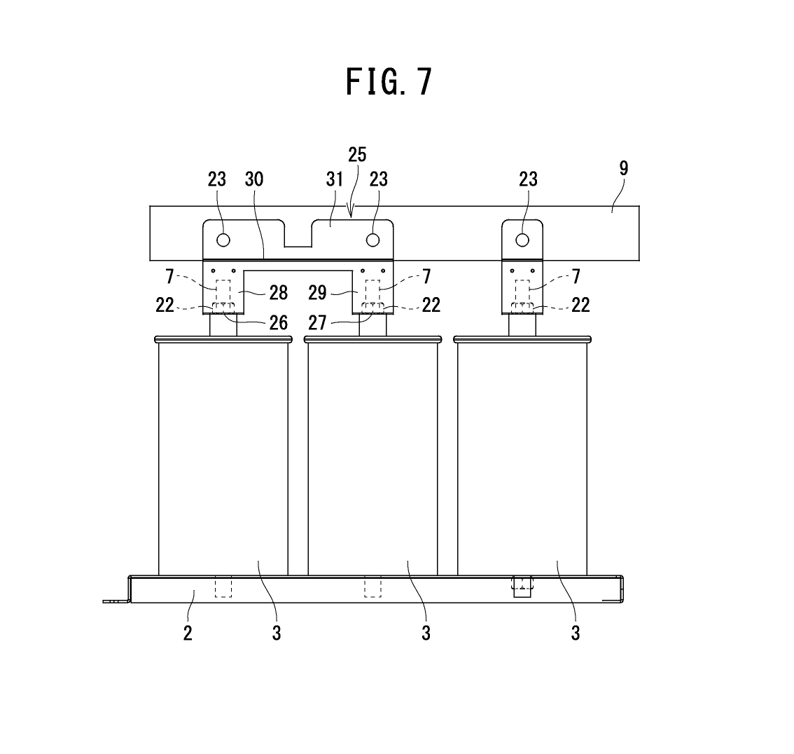

Next, FIG. 7 depicts a negative electrode-side intermediate conductor 25 of a second embodiment that connects the negative electrode terminals 7 of two capacitors 3 adjacent in each line to the negative electrode-side main conductor 9. In addition, the same structures as those in the first embodiment depicted by FIGS. 1 to 6 are denoted by the same reference signs, and descriptions thereof will be omitted.

The negative electrode-side intermediate conductor 25 of the second embodiment includes terminal connection portions 26 and 27, respectively, fixed to the negative electrode terminals 7 of the two capacitors 3 adjacent in each line, first non-contact portions 28 and 29 formed by bending the intermediate conductor at right angles from ends of the terminal connection portions 26 and 27, a second non-contact portion 30 that is formed by integrally connecting ends of the first non-contact portions 28 and 29 and bending the intermediate conductor at a right angle and that extends in parallel to the terminal connection portions 26 and 27, and a main conductor connection portion 31 that is formed by bending the intermediate conductor at a right angle from an end of the second non-contact portion 30 in a direction away from the terminal connection portions 26 and 27 and that has screw passing holes (unillustrated) formed therein.

Then, in the negative electrode-side intermediate conductor 25 of the second embodiment, the main conductor connection portion 31 is abutted against a side surface of the negative electrode-side main conductor 9 in a state where the first non-contact portions 28 and 29 and the second non-contact portion 30 are arranged at positions spaced apart from the positive electrode terminals 6. Then, the nuts 22 screwed to the male threads of the negative electrode terminals 7 of the two adjacent capacitors 3 are tightened to thereby fix the terminal connection portions 26 and 27 to the negative electrode terminals 7 of the two adjacent capacitors 3, and fixing screws 23 inserted through the screw passing holes of the main conductor connection portion 31 are screwed to the female threads of the negative electrode-side main conductor 9 to thereby fix the main conductor connection portion 31 to the negative electrode-side main conductor 9.

### [Advantageous Effects of Second Embodiment]

With the use of the negative electrode-side intermediate conductor 25 of the second embodiment thus formed, further reduction of the number of components can be achieved as compared to the method for connecting the capacitor group 1 by using the negative electrode-side intermediate conductor 12 of the first embodiment, thus allowing reduction of component cost and assembly cost.

In addition, when the positive electrode terminals 6 of the two capacitors 3 adjacent in each line are connected to the positive electrode-side main conductor 8 by using a positive electrode-side intermediate conductor having the same shape as that of the negative electrode-side intermediate conductor 25, the component cost and the assembly cost can be further reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

### REFERENCE SIGNS LIST

1 Capacitor group
2 Mounting base
3 Capacitor
4 Bottom surface
5 Top surface
6 Positive electrode terminal
7 Negative electrode terminal
8 Positive electrode-side main conductor
9 Negative electrode-side main conductor
11 Positive electrode-side intermediate conductor
12 Negative electrode-side intermediate conductor
13 Terminal passing hole
14 Terminal connection portion
15 First non-contact portion
16 Second non-contact portion
17 Screw passing hole
18 Main conductor connection portion
19 Deformation promoting hole
20 Nut
21 Fixing screw
22 Nut
23 Fixing screw
25 Negative electrode-side intermediate conductor
26, 27 Terminal connection portion
28, 29 First non-contact portion
30 Second non-contact portion
31 Main conductor connection portion

1. A capacitor connection structure of a power conversion device, comprising:
a capacitor with a built-in fuse, in which when the fuse is blown, a capacitor end face having a positive electrode terminal and a negative electrode terminal protruding from the capacitor end face is deformed outward into a convex shape;
a positive electrode-side main conductor and a negative electrode-side main conductor that are formed by a thick plate and that are connected to another electronic component at positions facing the capacitor end face;
a positive electrode-side intermediate conductor that connects the positive electrode terminal to the positive electrode-side main conductor; and
a negative electrode-side intermediate conductor that connects the negative electrode terminal to the negative electrode-side main conductor,
wherein when the capacitor end face is deformed into the convex shape, the positive electrode-side intermediate conductor and the negative electrode-side intermediate conductor are deformed along with inclination of the positive electrode terminal and the negative electrode terminal.

2. The capacitor connection structure of a power conversion device according to claim 1, wherein the positive electrode-side intermediate conductor is a member formed by bending a thin plate, and includes a positive electrode terminal connection portion fixed to the positive electrode terminal, a positive electrode non-contact portion that is formed from an end of the positive electrode terminal connection portion in a direction away from the negative electrode terminal and that is put into a non-contact state with respect to the positive electrode terminal when the positive electrode terminal is inclined due to the capacitor end face being deformed into the convex shape, and a positive electrode main conductor connection portion that is formed from an end of the positive electrode non-contact portion and fixed to the positive electrode-side main conductor.

3. The capacitor connection structure of a power conversion device according to claim 2, wherein, in a part of the positive electrode non-contact portion, a deformation promoting hole is formed that promotes deformation of the positive electrode non-contact portion along with the inclination of the positive electrode terminal.

4. The capacitor connection structure of a power conversion device according to claim 1, wherein the negative electrode-side intermediate conductor is a member formed by bending a thin plate, and includes a negative electrode terminal connection portion fixed to the negative electrode terminal, a negative electrode non-contact portion that is formed from an end of the negative electrode terminal connection portion in a direction away from the positive electrode terminal and that is put into a non-contact state with respect to the negative electrode terminal when the negative electrode terminal is inclined due to the capacitor end face being deformed into the convex shape, and a negative electrode main conductor connection portion that is formed from an end of the negative electrode non-contact portion and fixed to the negative electrode-side main conductor.

5. The capacitor connection structure of a power conversion device according to claim 4, wherein, in a part of the negative electrode non-contact portion, a deformation promoting hole is formed that promotes deformation of the negative electrode non-contact portion along with the inclination of the negative electrode terminal.

6. The capacitor connection structure of a power conversion device according to claim 1, wherein the positive electrode-side intermediate conductor and the negative electrode-side intermediate conductor are members having a same shape formed by bending a thin plate.

7. The capacitor connection structure of a power conversion device according to claim 1, wherein the positive electrode-side intermediate conductor and the negative electrode-side intermediate conductor are arranged within an area of the capacitor end face.

8. A method for connecting a capacitor group of a power conversion device, which is a method for connecting a plurality of capacitors arranged in line to the another electronic component by using the capacitor connection structure of the power conversion device according to claim 1, the method comprising:
arranging a plurality of capacitors in line so that the positive electrode terminal and the negative electrode terminal protruding from the capacitor end face are oriented in the same direction;
arranging the positive electrode-side main conductor having a long length along a direction in which the positive electrode terminals of the plurality of capacitors are arrayed;
arranging the negative electrode-side main conductor having a long length along a direction in which the negative electrode terminals of the plurality of capacitors are arrayed;
connecting the positive electrode terminal of each of the plurality capacitors to the positive electrode-side main conductor by the positive electrode-side intermediate conductor; and
connecting the negative electrode terminal of each of the plurality capacitors to the negative electrode-side main conductor by the negative electrode-side intermediate conductor.
